(19) United States
(12) Patent Application Publication
(10) Pub. No.: US 2026/0300053 A1
(43) Pub. Date: Oct. 1, 2026

(54) CIRCUIT-BREAKABLE QUEUE PROCESSOR FRAMEWORK FOR SOFTWARE APPLICATIONS AND SYSTEMS

(71) Applicant: ATLASSIAN US, INC., San Francisco, CA (US)

(72) Inventors: Berke Tezergil, Ankara (TR); Batuhan Kama, Ankara (TR)

(21) Appl. No.: 19/095,804

(22) Filed: Mar. 31, 2025

(51) Int. Cl. G06F 9/54

(52) U.S. Cl. CPC G06F 9/546

(57) ABSTRACT

Various embodiments are directed to a circuit-breakable queue processor framework. A queue reconfiguration trigger associated with a selected message queue of a plurality of message queues for a selected service may be detected. A service message set within the selected message queue may be detected based on the queue reconfiguration trigger. Each service message of the service message set may define a service message configuration field set. A configuration field subset of the service message configuration field set may be identified based on the queue reconfiguration trigger. At least one subsequent incoming service message may be dynamically filtering from the selected message queue based on the configuration field subset.

### FIELD OF INVENTION

The present disclosure relates to message queue techniques, and more particularly to circuit-breakable queue processor framework for software applications and systems.

### BACKGROUND

Applicant has identified many deficiencies and problems associated with message queue techniques and systems. Through applied effort, ingenuity, and innovation, these identified deficiencies and problems have been solved by developing solutions that are in accordance with the embodiments of the present invention, many examples of which are described in detail herein.

### SUMMARY

In accordance with one aspect of the present disclosure, a computer-implemented method for circuit-breakable queue processor framework is provided. In some embodiments, the computer-implemented method comprises detecting a queue reconfiguration trigger associated with a selected message queue of a plurality of message queues for a selected service; detecting a service message set within the selected message queue based on the queue reconfiguration trigger, wherein each service message of the service message set defines a service message configuration field set; identifying a configuration field subset of the service message configuration field set based on the queue reconfiguration trigger; and dynamically filtering at least one subsequent incoming service message from the selected message queue based on the configuration field subset.

In some embodiments, the configuration field subset comprises an entity identifier field.

In some embodiments, dynamically filtering the at least one subsequent incoming service message based on the configuration field subset comprises detecting the at least one subsequent incoming service message; determining configuration field data corresponding to the configuration field subset for the at least one subsequent incoming service message; comparing the configuration field data to a target configuration field data; and dynamically filtering the configuration field subset in response to determining that the configuration field data matches the target configuration field data.

In some embodiments, the target configuration field data comprises an entity identifier associated with the service message set.

In some embodiments, dynamically filtering the at least one subsequent incoming service message comprises deleting the at least one subsequent incoming service message in response to receiving the at least one subsequent incoming service message.

In some embodiments, dynamically filtering the at least one subsequent incoming service message comprises moving the at least one subsequent incoming service message to a holding queue.

In some embodiments, the example computer-implemented method further comprises moving the service message set from the selected message queue to a holding queue.

In some embodiments, example computer-implemented method further comprises deleting the service message set from the selected message queue.

In some embodiments, the queue reconfiguration trigger comprises an elevated queue message event, wherein detecting the queue reconfiguration trigger comprises determining a message count associated with the selected message queue exceeds a message count threshold.

In accordance with another aspect of the present disclosure, an apparatus for circuit-breakable queue processor framework is provided. The apparatus in some embodiments comprises at least one processor and at least one memory including program code, the at least one memory and the program code configured to, with the at least one processor, cause the apparatus to at least detect an elevated queue message event associated with a selected message queue of a plurality of message queues for a selected service; detect a service message set within the selected message queue based on the elevated queue message event, wherein each service message of the service message set defines a service message configuration field set; identify a configuration field subset of the service message configuration field set based on the elevated queue message event; and dynamically filter at least one subsequent incoming service message from the selected message queue based on the configuration field subset.

In some embodiments, dynamically filtering the at least one subsequent incoming service message based on the configuration field subset comprises detecting the at least one subsequent incoming service message; determining configuration field data corresponding to the configuration field subset for the at least one subsequent incoming service message; comparing the configuration field data to a target configuration field data; and dynamically filtering the configuration field subset in response to determining that the configuration field data matches the target configuration field data.

In some embodiments, dynamically filtering the at least one subsequent incoming service message comprises deleting the at least one subsequent incoming service message in response to receiving the at least one subsequent incoming service message.

In some embodiments, dynamically filtering the at least one subsequent incoming service message comprises moving the at least one subsequent incoming service message to a holding queue.

In some embodiments, the apparatus is further caused to move the service message set from the selected message queue to a holding queue.

In some embodiments, the apparatus is further caused to delete the service message set from the selected message queue.

In some embodiments, detecting the elevated queue message event comprises determining a message count associated with the selected message queue exceeds a message count threshold.

In some embodiments, the configuration field subset comprises at least an entity identifier field.

In accordance with another aspect of the present disclosure, at least one non-transitory computer-readable storage medium for circuit-breakable queue processor framework is provided. In some embodiments, the at least one non-transitory computer-readable storage medium comprises computer coded instructions configured to, when executed by at least one processor detect a queue reconfiguration trigger associated with a selected message queue of a plurality of message queues for a selected service; detect a service message set within the selected message queue based on the queue reconfiguration trigger, wherein each service message of the service message set defines a service message configuration field set comprising at least an entity identifier field; identify a configuration field subset of the service message configuration field set based on the queue reconfiguration trigger; and dynamically filter at least one subsequent incoming service message from the selected message queue based on the configuration field subset.

In some embodiments, the queue reconfiguration trigger comprises an elevated queue message event, wherein detecting the queue reconfiguration trigger comprises determining a message count associated with the selected message queue exceeds a message count threshold.

In some embodiments, dynamically filtering the at least one subsequent incoming service message based on the configuration field subset comprises detecting the at least one subsequent incoming service message; determining configuration field data corresponding to the configuration field subset for the at least one subsequent incoming service message; comparing the configuration field data to a target configuration field data; and dynamically filtering the configuration field subset in response to determining that the configuration field data matches the target configuration field data, wherein dynamically filtering the at least one subsequent incoming service message comprises moving the at least one subsequent incoming service message to a holding queue.

### BRIEF DESCRIPTION OF THE SEVERAL VIES OF THE FIGURES

Having thus described some embodiments in general terms, references will now be made to the accompanying drawings, which are not drawn to scale, and wherein:

FIG. 1 illustrates a block diagram of a system architecture within which at least some embodiments of the present disclosure may operate.

FIG. 2 is a block diagram of an apparatus in accordance with at least some embodiments of the present disclosure.

FIG. 3 illustrates a sequence diagram of example circuit-breakable queue processor framework in accordance with at least some embodiments of the present disclosure.

FIG. 4 illustrates a flowchart of an example process for circuit-breakable queue processor framework in accordance with at least some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Overview

The present disclosure addresses critical challenges in modern software applications and systems, particularly managing various queue events including, but not limited to, elevated queue message events. Traditional message queue systems often struggle with scalability and adaptability when dealing with sudden increases in message volume, misconfiguration issues, or other queue events. This limitation has become increasingly problematic as software environments have grown more intricate, with resources and message processing spanning multiple levels/layers of service-oriented architectures. The current landscape of message queue management is characterized by a lack of consistent frameworks that can effectively work across various types of queue events including elevated queue message events.

Existing approaches to this problem have significant limitations. Many current solutions either do not adapt well to all types of message queue overload scenarios or require manual intervention to handle elevated queue message events and other queue events. This approach of modifying message queue processors for particular incidents often results in solutions that do not scale effectively. As service-oriented architectures grow in complexity and size, these tailored solutions become increasingly difficult to manage and maintain, leading to potential system degradation and administrative overhead.

Traditional message queue systems/architecture often struggle to effectively manage scenarios where the number of messages in a queue rapidly increases, potentially overwhelming the system's processing capacity. These systems/architecture typically lack dynamic mechanisms to quickly identify and isolate problematic message streams, leading to degraded performance across the entire messaging infrastructure. Traditional approaches to handling queue overload situations, such as implementing static rate limiting or manually intervening to modify message processing logic, are often too slow or inflexible to adequately address rapidly evolving message queue events.

Many existing message queue implementations are not equipped to dynamically adapt to sudden changes in message volume or characteristics. These systems may continue to process messages in a first-in-first-out manner even when certain message streams are causing system-wide performance issues. The inability to quickly identify and isolate problematic message patterns can lead to cascading failures, where processing delays in one queue impact the performance of dependent systems and services.

Example embodiments of the present disclosure provide a consistent circuit-breakable queue processor framework designed to enhance the scalability, flexibility, and manageability of message queue systems in the face of elevated queue message events and other queue events. The disclosed techniques address these challenges with existing message queue systems by structuring and defining dynamic filtering criteria (e.g., configuration field subsets) that can be applied to incoming service messages based on configuration field subsets identified during elevated queue message events or other queue events.

Example embodiments of the present disclosure provide circuit-breakable queue processor framework that enables rapid mitigation of elevated queue message events. The disclosed systems implement dynamic filtering mechanisms that can quickly isolate problematic message streams based on configurable filtering criteria, without requiring system-wide changes or manual intervention.

This approach provides a unified solution to the challenges posed by complex asynchronous flows in modern software environments by offering a scalable and adaptable circuit-breakable queue processor framework for managing elevated queue message events across diverse service-oriented architectures. The framework enables automatic detection of elevated queue message events, identification of problematic message sets, and dynamic filtering of subsequent incoming messages based on configurable filtering criteria, without requiring system restarts and/or manual code changes.

The present disclosure introduces techniques for dynamically identifying configuration field subsets associated with problematic message patterns, which allows for targeted filtering of subsequent incoming messages based on specific message characteristics, effectively implementing a circuit breaker pattern for message queues. By selectively routing or discarding messages that match identified problematic patterns, the system can prevent queue overload situations and maintain overall system stability.

Furthermore, the disclosed embodiments provide flexible mechanisms for handling filtered messages, including options to delete them or route them to separate holding queues for later processing or analysis. This approach ensures that potentially important data is not lost while still allowing the primary message queues to continue processing non-problematic messages efficiently. The dynamic nature of these circuit-breakable queue processor framework enables systems to adapt quickly to changing message patterns and maintain optimal performance in the face of unexpected increases in message volume or processing demands.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client computing device,” “computing device,” “client computing entity” “network device,” “computer,” “user equipment,” and similar terms may be used interchangeably to refer to a computer comprising at least one processor and at least one memory. In some embodiments, the client computing device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client computing device” may refer to computer hardware and/or software that is configured to access a service made available by a server. The server is often, but not always, on another computer system, in which case the client accesses the service by way of a network. Embodiments of client computing devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “circuitry” may refer to hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The terms “application,” “software application,” “app,” “product,” “service” or similar terms refer to a computer program or group of computer programs designed to perform coordinated functions, tasks, or activities for the benefit of a user or group of users. A software application can run on a server or group of servers (e.g., a physical or virtual servers in a cloud-based computing environment). In certain embodiments, an application is designed for use by and interaction with one or more local, networked or remote computing devices, such as, but not limited to, client computing devices. Non-limiting examples of an application comprise issue tracking software applications, project management, workflow engines, service desk incident management, team collaboration suites, cloud services, word processors, spreadsheets, accounting applications, web browsers, email clients, media players, file viewers, videogames, audio-video conferencing, and photo/video editors. In some embodiments, an application is a cloud product. In some examples, the application is associated with a multi-layer service-oriented platform.

The term “data object” refers to a data structure, associated with one or more data elements or values in a computer-readable storage medium and/or computer-readable transmission medium, that represents content that is configured for use or display by one or more software applications, services, and/or microservices. A data object may take the structural form of a vector or other appropriate data structure for representing data. A data object may include metadata and may be stored via computer-readable storage medium (e.g., with a repository associated with a server). A data object (or one or mor values thereof) may be transmittable between services, microservices, applications, modules, computing devices, and/or systems by way of a computer-readable transmission medium (e.g., telecommunication signals, wired/wireless electrical signals, and/or the like). In some embodiments, a data object may comprise a plurality of data objects. A data object may be configured to follow a predefined format.

The term “application programming interface” or “API” refer to a computing interface that defines indication inputs between applications, services, microservices, computing devices, repositories, and/or the like of an issue tracking system or a multi-layer service-oriented platform. An application programming interface may define formatting for one or more of a programming code call, request, function, procedure, notification, data object, data structure, or the like. Non-limiting examples of an application programming interface may include JavaScript Object Notation (JSON), Extensible Markup Language (XML), Simple Object Access Protocol (SOAP), Hypertext Markup Language (HTML), the like, or combinations thereof.

The term “multi-layer service-oriented platform” refers to a complex network computing environment associated with a multitude of computing devices, applications, services, and microservices. For example, in some embodiments, a multi-layer service-oriented platform includes dozens of applications that are supported by 1000+ services operating within a cloud-based platform. Example multi-layer service-oriented platforms may comprise a federated network of computing devices, and/or a plurality of database platforms (e.g., servers, hard-drives, etc.). Applications and services or microservices of example multi-layer service-oriented platforms may be hosted by internal resources or external resources. Multi-layer service-oriented platforms may support multiple applications that are configured for the collection of information (e.g., in the form of application data objects), storing of information collected, managing of information collected, processing of information collected and/or providing other services, individually or collectively, for the benefit of a user. Each software application may include a number of features, with many features (e.g., user authentication features) shared between multiple software applications. Other features may be supported only by one associated software application or a defined subset of software applications. A given multi-layer service-oriented platform could support hundreds of software applications and hundreds of thousands of features. Those applications and features could be supported by thousands of services and microservices that exist in vast and ever-changing interdependent layers. Software development teams may release code updates that change various software services, launch new software services, change existing features of existing software applications, add new software applications, add new software application features to existing software applications, and/or the like. Non-limiting example of applications and/or tools that may be included in a multi-layer service-oriented platform, include Jira Software® by Atlassian, Inc. Jira Service Management® by Atlassian Inc., Confluence® by Atlassian, Inc., JIRA Service Desk by Atlassian®, Inc., Loom® video messaging, and Trello®.

The term “service message”, “message” or similar terms refers to data object that is temporarily stored in a message queue for processing by a recipient/consumer, such as for processing by a queue processor associated with a message queue system. In some examples, a service message comprises structured data objects that conform to a predefined schema or format. A service message may define one or more fields, including one or more configuration fields. Non-limiting examples, of such fields that may be defined by a service message include message identifier, timestamp, message type, payload, and metadata. By way of example, the payload may include the actual data or command to be processed, while metadata may include routing information, priority levels, or other attributes that guide handling of service message. Service messages are fundamental units of communication in asynchronous, message-based architectures.

In some examples, service messages may encapsulate information or commands that need to be transmitted between different components or services within a distributed system. Service messages may be implemented using serialization techniques to convert complex data structures into a format suitable for transmission and storage. Common serialization formats include JSON, XML, or binary protocols like Protocol Buffers. These serialized messages are then placed into message queues, which act as buffers between producers and consumers of the messages such as, for example between a system and system users (e.g., entities such as a user, an organization, an enterprise, or the like). Service messages enable asynchronous communication patterns, allowing different parts of a system to operate independently and at their own pace. This asynchronous nature improves system resilience and scalability, as components can continue to function even if other parts of the system are temporarily slow or unavailable. Service messages also facilitate improved resource utilization, as processing may be distributed and load-balanced across multiple consumers. In some examples, in addition to communication, service messages may be used to implement various architectural patterns such as event sourcing, where the state of an application is determined by a sequence of events, or command query responsibility segregation (CQRS), where read and write operations are separated to optimize for different access patterns.

The term “event” refers to occurrences or changes in the state of data, processes, components, resources, applications, or systems. Events are fundamental components in asynchronous architectures and event-driven systems. Events represent significant happenings or state changes that may trigger actions or responses within a software system. Events may be generated by various sources, such as user interactions, system processes, or external systems. In the context of message queues and asynchronous processing, events may correspond to the arrival of new messages, changes in queue status, the completion of processing tasks, and/or the like. An example of an event that may be associated with message queues include, but is not limited to, elevated queue message events. Events may be implemented as data structures or objects that encapsulate relevant information about the occurrence or changes. Such data structures or objects may include attributes such as event type, timestamp, source identifier, and payload data. In distributed systems, events may be serialized and transmitted across network boundaries, allowing different components or services to react to changes in other parts of the system. Events play a crucial role in decoupling system components and enabling loose coupling between producers and consumers of information. This decoupling allows for more flexible and scalable architectures, as components can be added, removed, or modified without directly affecting others, as long as they adhere to the established event interfaces.

The term “elevated queue message event” refers to a type of event associated with a message queue. An elevated queue message event indicates that the message queue has reached a predefined threshold. For example, an elevated queue message event may occur when a count/number of the messages (message count) in message queue exceeds a message count threshold. Elevated queue message events serve as important indicators of system health and performance in asynchronous architectures. An elevated message event may indicate potential issue(s) or current issues with the message queue or message processing pipeline, such as processing delays and system overload, misconfiguration, and/or the like. In some examples, elevated queue message events may be associated with an entity identifier. For example, the message count in a message queue may exceed the message count threshold for the message queue due to sudden increase in the number of messages associated with the entity identifier sent to the message queue or otherwise within the message queue.

In some examples, elevated queue message events may be detected using monitoring and alerting systems integrated with the message queue infrastructure. The monitoring and alerting systems may be configured continuously track queue metrics, such as message count, and generate elevated queue message events or alerts when thresholds such as message count threshold have been reached or exceeded. The detection of an elevated queue message event may involve a combination of real-time metric evaluation and threshold comparison, which may be implemented using time-series databases to store historical queue metrics, coupled with alerting rules that define the conditions for triggering an event. In some examples, machine learning techniques may be employed to detect anomalies in queue behavior that may indicate an elevated queue message event.

Elevated queue message events may be used to trigger automated responses such as scaling up processing resources, implementing backpressure mechanisms, or activating circuit breakers to prevent system overload. Elevated queue message events may also provide valuable insights for capacity planning and system optimization. In some examples, by analyzing historical patterns and current trends, the system may anticipate potential message queue overload situations before they occur, allowing for proactive measures to be taken. This may involve techniques such as time series forecasting or machine learning models trained on historical queue behavior data.

The term “message count” refers to a metric indicative and/or representative of the number of service messages in a message queue at a particular time and/or length of time. Message count is a metric used to monitor and manage the state of message queues in asynchronous processing systems. Message count provides a quantitative measure of the current load on a message queue and may be used to trigger various system behaviors or alerts. Message count may be implemented as a counter or gauge metric associated with a message queue. This metric (e.g., message count) may be dynamically updated as messages are added to or removed from the queue. Message count may be stored and tracked using time-series databases or specialized monitoring systems. These systems allow for efficient storage and retrieval of historical count data, enabling trend analysis and capacity planning. Real-time message count information may be exposed through APIs or management interfaces, allowing external systems to query and react to changes in queue state.

Message count may be leveraged in various queue management operations. Message count may be used in load balancing algorithms to distribute processing load across multiple consumers. For example, a system might use message count to determine which message queue to route new messages to or which consumer should process the next message. Message count may also be leveraged in auto-scaling decisions, where processing resources are dynamically adjusted based on queue load. Message count may be combined with other metrics such as message age, processing rate, and queue throughput to provide a more comprehensive view of the health of a message queue. Machine learning models may be trained on these metrics to predict future message queue states and preemptively adjust system resources or processing strategies. Message count may be used in implementing backpressure mechanisms, where producers are slowed down or temporarily blocked when message queue counts reach certain thresholds (e.g., indicative of elevated queue message events). This helps prevent message queue overflow and ensures that the system remains within its processing capacity. Message count may also be used in monitoring and alerting systems to detect anomalies or potential issues in the message processing pipeline.

The term “message count threshold” refers to a data entity indicative and/or representative of a predefined limit or value used as a reference point to detect elevated queue message events. Message count thresholds may be used in managing and monitoring message queues, serving as triggers for various system behaviors and alerts, including elevated queue message events. A message count threshold may be implemented as configurable parameters within a queue management system or associated monitoring tools. In some examples, message count thresholds may be static values, such as a fixed number of messages, or dynamic values that adjust based on system conditions or historical patterns. A message count threshold may be stored in configuration databases or distributed configuration management systems. This allows for dynamic updates to threshold values without requiring system restarts. In some implementations, machine learning models may be used to dynamically adjust message count thresholds based on historical queue behavior and/or current system load.

Message count thresholds may be used to trigger elevated queue message events when the number of messages in a message queue exceeds the message count threshold. This may initiate various automated responses such as scaling up processing resources, activating circuit breakers, or sending alerts to system administrators. By setting appropriate message count thresholds, systems may proactively manage queue loads and prevent processing backlogs. Message count thresholds may be used in conjunction with other metrics to implement more sophisticated queue management strategies. For example, multiple thresholds may be defined to trigger different levels of response based on the severity of the message queue overload. Lower thresholds may trigger minor adjustments, while higher thresholds may initiate measures such as temporarily rejecting new messages (e.g., filtering incoming messages).

In some implementations, message count thresholds may be complemented by time-based thresholds. For instance, a system may, additionally, trigger an event when a certain message count persists for a specified duration. This may facilitate distinguishing between temporary spikes in queue load and more sustained issues that require intervention. Message count thresholds may be used in load balancing across multiple message queues, where messages are routed to different queues based on their current counts relative to defined thresholds. Message counts may also be used in capacity planning, where historical threshold breaches are analyzed to inform decisions about system scaling and resource allocation.

The term “queue reconfiguration trigger” refers to a signal, data, computer readable instructions, messages (e.g., an inter-service message, intra-service message, network message, etc.), occurrences, action, conditions, or request that invokes or otherwise initiates, whether directly or indirectly and whether actively or passively, a process such as modification and/or update to queue configuration. Non-limiting examples of a queue reconfiguration trigger includes elevated queue message events, queue configuration update requests, and/or the like.

The term “queue configuration update request” refers to a signal, data, computer readable instructions, messages (e.g., an inter-service message, intra-service message, network message, etc.), occurrences, action, conditions, or the like indicative and/or representative of a request to update configuration of a message queue. In some examples, a queue configuration update request may originate from a user.

The term “queue configuration” refers to one or more defined parameters, routing rules, and/or message processing rules for a message queue. Non-limiting examples of defined parameters for a message queue may include queue name, message size limits, message retention periods, delivery delay, configuration key, processing action (e.g., process, delete, re-route to another queue, and/or the like) and/or the like.

The term “message queue” refers to software components that supports or enables asynchronous communication between components of a system(s). In some examples, such systems may be associated with a multi-layer service-oriented platform. Message queues may act as intermediaries between and/or within systems that generate messages (e.g., producers) and systems that receive messages and act on it (consumers). Message queues may be implemented as distributed systems that provide reliable message storage and delivery. Message queues may use persistent storage mechanisms to ensure that messages are not lost in case of system failures. Example implementations of message queues include disk-based queues for durability, in-memory queues for high performance, or a combination thereof (e.g., hybrid approach). Message queues may be built on top of specialized data structures optimized for fast insertions and retrievals. These may include circular buffers, linked lists, or more complex structures designed to handle concurrent access efficiently. In distributed implementations, techniques such as sharding and replication are used to ensure scalability and fault tolerance. Message queues may be leveraged to decouple different components of a system, allowing the components to operate asynchronously. This decoupling improves system resilience and scalability, as components may continue to function independently even if other parts of the system are temporarily slow or unavailable. Message queues facilitate load leveling, where spikes in message production may be smoothed out over time, preventing overload of consuming systems.

Message queues may support various messaging patterns, including point-to-point (e.g., where each message is consumed by a single consumer) and publish-subscribe (e.g., where multiple consumers can receive copies of the same message). Message queues may incorporate features such as message routing based on content or metadata, message transformation, and integration with external systems. A message queue system may support distributed transactions, allowing for atomic operations across multiple message queues or different types of data stores. Message queues may be used in implementing event sourcing patterns, where the state of an application is determined by a sequence of events stored in a queue. Message queues may be used to implement workflow systems, where each message represents a task or step in a larger process. In microservices architectures, message queues may serve as the primary means of inter-service communication, enabling loose coupling between services.

The term “holding queue” refers to a type of queue that is designed to hold service unprocessed messages, including messages that were unsuccessfully processed after multiple attempts and messages that were designated as not to be processed by the message queue. A holding queue may be referred to as a dead-letter queue (DLQ). Holding queues may be implemented as separate queue structures within the same messaging system as the primary/main queues. Holding queues may share similar underlying technologies and data structures with regular message queues (e.g., primary queue). In some example, holding queue may include metadata to track information about why messages were moved to the holding queue. Holding queues may be integrated with the main message processing pipeline configurable policies. These policies may define conditions under which messages should be moved to the holding queue, such as after a certain number of processing attempts, when they exceed a maximum age, or when they fail specific validation criteria. The implementation may involve interceptors or middleware components that apply these policies during message processing.

Holding queues may be used to manage problematic messages that cannot be processed normally. By moving these messages to a separate queue, the system prevents such messages from blocking the processing of other messages in the main queue. This improves the overall reliability and throughput of the system. In some examples, holding queues may provide a mechanism for manual intervention, allowing system administrators to inspect, retry, or discard problematic messages. Holding queues may be leveraged to implement reliable messaging patterns. Holding queues may be leveraged to ensure that messages are not lost, even if they cannot be processed immediately. This is particularly important in systems that require guaranteed message delivery or need to maintain a complete audit trail of messages.

In some implementations holding queues may be integrated with automated error handling and recovery systems. These systems may attempt to automatically resolve issues with messages in the holding queue, such as retrying them after a delay or applying transformations to correct common errors. Machine learning techniques may be employed to analyze patterns in messages sent to holding queues, helping to identify and preemptively address systemic issues in message production or processing. Holding queues may be leveraged to implement staged fallback mechanisms, where messages may move through a series of holding queues with increasingly aggressive retry policies before being considered truly undeliverable. Holding queues may also be used as part of a broader observability strategy, with messages in holding queues serving as indicators of potential issues in other parts of the system.

The term “queue identifier” refers to one or more datum by which a queue may be identified. For example, a queue identifier may be configured to uniquely identify a queue (e.g., a message queue or holding queue) from other queues. In some examples, the queue identifier may be in the form of text string(s), numerical character(s), alphabetical character(s), alphanumeric code(s), American Standard Code for information Interchange (ASCII) character(s), a pointer, a memory address, or other data.

The term “entity identifier” refers to one or more datum by which an entity may be identified. For example, an entity identifier may be configured to uniquely identify an entity from other entities. In some examples, the entity identifier may be in the form of text string(s), numerical character(s), alphabetical character(s), alphanumeric code(s), American Standard Code for information Interchange (ASCII) character(s), a pointer, a memory address, or other data.

The term “service message set” or “message set” refers to a collection of one or more service messages within a message queue. The service message(s) in a service message set may share common characteristics, such as a common entity identifier or other characteristics. For example, each service message in a service message set may be associated with the same entity identifier corresponding to a specific entity. In some examples, configuration field subset associated with a service message set within a message queue may be leveraged to facilitate filtering, such as in response to elevated queue message events. For example, an elevated queue message event may occur due to the service message set. For example, the service message set may be associated with asynchronous flow or other factors that cause the message count associated with a message queue to exceed a message count threshold. In this regard, a service message set may refer to a collection of one or more messages with a message queue and that caused the occurrence of an elevated queue message event with respect to the message queue.

The term “service message configuration field set”, “message configuration field set”, or similar terms refers to one or more fields in a service message. A service message configuration field set may define the structure and/or metadata associated with a service message, providing crucial information for message routing, processing, and management within a messaging system. A service message configuration field set may be implemented as part of the message schema or data model. This may involve using structured data formats like JSON or Protocol Buffers to define a consistent set of fields for each message type. In some examples, service message configuration field sets may be implemented using dynamic schemas that allow for runtime addition or modification of fields. In some examples, the implementation of service message configuration field sets may include serialization and deserialization mechanisms to convert between the in-memory representation of messages and their serialized form for transmission or storage. This may include optimizations for efficient parsing and validation of field values, as well as techniques for handling schema evolution over time.

Service message configuration field sets may be used to provide context and control information for message processing. Example of service message configuration fields include message identifiers, entity identifier, timestamps, queue identifier, recipient identifier, routing information, priority levels. Service message configuration field sets may guide how messages are handled within the system, determining aspects like queue selection, processing order, and retry behavior. Service message configuration field sets may be leveraged to facilitate message filtering and routing in response to certain events including, but not limited to, elevated queue message events. A message queue system may use message configuration field values corresponding to service message configuration field sets to determine which messages to process or filter, enabling content-based routing strategies. This allows for flexible and dynamic message distribution based on the needs of different parts of the system.

Service message configuration field sets may support various operational capabilities such as message tracing and debugging. A service message configuration field set may capture information about message origins, processing history, and related operations that enable detailed analysis of message flows through complex distributed systems. This may allow for troubleshooting issues and optimizing system performance. In some implementations, service message configuration field sets may be used to implement dynamic processing behaviors. For example, message configuration fields may specify custom processing logic or parameters, allowing for flexible, message-specific handling without requiring changes to the underlying processing infrastructure. Machine learning models may be trained to optimize processing strategies based on patterns in configuration field values. Service message configuration field sets may be used in implementing access control and data governance policies. Service configuration fields specifying security classifications or data sensitivity levels may be used to enforce appropriate handling and access restrictions throughout the message lifecycle. Service message configuration field sets may be leveraged for analytics and reporting, providing rich metadata for aggregation and analysis of message patterns and system behavior.

The term “configuration field subset” refers to one or more of the fields from a service message configuration field set. A configuration field subset may be used by a queue processing system/architecture to facilitate filtering of service messages. Configuration field subsets represent a focused selection of fields from a message configuration field set and that is specifically chosen to facilitate filtering of service messages. Configuration field subsets may be implemented as a defined subset of a message schema or data model. This may include creating separate data structures or indexes that only include the relevant fields, optimizing for quick access and comparison operations. In some implementations, configuration field subsets may be dynamically defined based on system conditions or processing requirements. The implementation of configuration field subsets may involve specialized data structures and algorithms optimized for fast field extraction and comparison. This may include techniques like bitmap indexing or bloom filters to quickly determine if a message matches certain criteria based on its configuration field subset.

Configuration field subsets may be used to enable dynamic filtering and routing of service messages, including incoming service messages. Such filtering and routing may be performed in response to an elevated queue message event. Configuration field subsets may be used in implementing dynamic routing and load balancing strategies. Based on the values in the configuration field subsets, messages may be quickly directed to appropriate queues or processors, helping to distribute processing load, manage system resources effectively, and handle elevated queue message events. Configuration field subsets may support important operational capabilities such as message prioritization and selective processing. For example, in scenarios where not all messages can be processed immediately, the fields in the configuration field subsets may be used to quickly identify high-priority or time-sensitive messages that should be handled first. Configuration field subsets may be used in implementing fine-grained access control policies, where fields in the configuration field subset determine message visibility or processing permissions for different system components or users. Configuration field subsets may be leveraged for real-time monitoring and alerting, allowing systems to quickly identify and respond to specific patterns or anomalies in message flows based on subset field values.

The term “target configuration field data” refers to a reference data or criteria against which service messages may be evaluated for filtering or routing decisions, especially in scenarios dealing with elevated queue message events. For example, when certain thresholds or conditions are met, as indicated by matches against the target configuration field data, the system may automatically adjust its behavior to prevent overload or cascading failures. Such behavior may include filtering or routing decisions. Target configuration field data may be determined in real-time. In some examples, target configuration field data may be determined in real-time in response to an elevated queue message event associated with a message queue and based on a service message set within the message queue. For example, target configuration field data may be implemented as field value(s) corresponding to a configuration field subset for a service message set. Target configuration field data may be compared to data (e.g., field values) corresponding to a configuration field subset for an incoming service message to determine whether to filter out the service message. By comparing incoming service messages against the target configuration field data, a system may quickly determine which messages should be processed normally and which should be redirected to alternative queues or deleted, and which might need special handling or rejection. An example of an alternative queue is a holding queue such as dead-letter-queue (DLQ). The implementation of target configuration field data may include sophisticated matching algorithms that can handle various comparison types, including exact matches, pattern matching, range checks, and/or more complex logical expressions. These algorithms may be designed to operate efficiently on high volumes of messages, minimizing the processing overhead for each comparison.

The term “filtering” refers to a computer process for selectively processing service messages. Filtering may be used in facilitating or implementing circuit breaker architecture, where certain messages are filtered out during or in response to system overload conditions, such as elevated queue message events, in response to queue configuration update requests, and/or in response to other queue reconfiguration triggers. Filtering may be implemented using algorithms that evaluate messages against predefined rules or conditions. In some examples, these algorithms may range from comparisons of field values to more complex pattern matching or machine learning-based classification. In some examples, the implementation may involve optimized data structures like hash tables or tree structures to enable rapid evaluation of filtering criteria.

The term “incoming service message” refers to a service message that is currently sent (e.g., by or within an application or service) for temporary storage in a message queue for later processing. In some examples, incoming service message may comprise a message that is currently sent for temporary storage in a message queue following an elevated queue message event and within a time period.

The term “queue processor” refers to a type of processor configured to process service messages in a message queue. Queue processors may be configured to consume messages from message queues and execute the associated logic or operations (e.g., process the messages). This may include tasks such as data transformation, database updates, triggering external services, or generating new messages for further processing. Queue processors may be configured to maintain the flow of data and operations in asynchronous systems. Queue processors may be implemented as software components that run continuously, polling message queues for new messages or subscribing to queue events. Queue processor may operate in a multi-threaded or distributed manner to handle high message volumes efficiently. The implementation may involve techniques like batch processing, where multiple messages are retrieved and processed together for improved efficiency. Queue processors may be designed with fault tolerance consideration, incorporating features like automatic retries for failed messages, DLQs for unprocessable messages, and checkpointing mechanisms to track processing progress. In some examples, queue processors may be implemented as scalable, stateless components that may be easily replicated to handle increased load. Queue processors enable decoupling between message producers and consumers. Queue processors allow for independent scaling of different system components, as the rate of message production may be different from the rate of processing. This decoupling improves system resilience and flexibility.

Queue processors may support implementing backpressure mechanisms. When processing capacity is limited, queue processors may slow down their consumption rate, allowing queues to buffer messages and prevent system overload. Queue processor may enable implementation of priority processing, where certain types of messages may be processed ahead of others based on one or more rules. Queue processors might incorporate adaptive processing strategies. This may involve dynamically adjusting batch sizes, processing priorities, or routing decisions based on current system load or message characteristics. Machine learning models may be used to optimize these decisions, predicting processing requirements or detecting anomalies in the message stream. Queue processors may be used in implementing event-driven architectures, where queue processors act as event handlers responding to specific types of events in the system. Queue processor may be used in data pipeline scenarios, where queue processors perform stages of data transformation or enrichment as part of a larger data processing workflow.

The term “asynchronous flows” refers to an increase in the number of service messages associated with a particular entity identifier in a particular message queue due to misconfiguration, such that the queue processors may be unable to process the messages on time. Asynchronous flows may arise in scenarios where external factors, like user behavior or integrated system performance, can lead to sudden spikes in message volume. For example, asynchronous flows may be manifested as a rapid accumulation of messages in a queue, outpacing the system's ability to process them. Asynchronous flows may cause occurrence of elevated queue message events. Asynchronous may be of significant a concern in high-volume, event-driven systems where message production rates can vary widely or where processing requirements can be unpredictable. Uncontrolled asynchronous flows can lead to increased latency, resource exhaustion, or system failure if queues become overwhelmed.

In some embodiments, the term “asynchronous architecture” refers to an architecture associated with a message queue that facilitates asynchronous communication and processing by allowing a sender to send a message without waiting for a response from the receiver. Asynchronous architectures are fundamental to building scalable, resilient, and loosely coupled distributed systems. From a technical perspective, asynchronous architectures are typically implemented using message queues or event streaming platforms as core components. These systems provide persistent storage for messages or events, ensuring reliable delivery even if receivers are temporarily unavailable. Some implementations might use technologies like Apache Kafka, RabbitMQ, or cloud-based services like Amazon SQS or Azure Service Bus. The implementation of asynchronous architectures may involve sophisticated mechanisms for message routing, load balancing, and error handling. This may include techniques like message partitioning for parallel processing, dead letter queues for handling failed messages, and exactly-once delivery semantics to ensure message processing reliability.

Asynchronous architectures are primarily used to decouple different components or services within a distributed system. By allowing components to communicate without direct dependencies, these architectures enable greater system flexibility, scalability, and fault tolerance. Senders can continue operating without being blocked by slow or unavailable receivers, and receivers can process messages at their own pace without being overwhelmed by rapid senders. In large-scale systems, asynchronous architectures play a crucial role in managing system load and ensuring responsiveness. Asynchronous architectures allow for effective load leveling, where spikes in incoming requests or data can be smoothed out over time, preventing individual components from becoming bottlenecks. This is particularly valuable in scenarios with variable or unpredictable workloads. Asynchronous architectures may also support important patterns for building resilient systems. Asynchronous architectures enable retry mechanisms for handling transient failures, circuit breaker patterns for managing persistent issues, and event sourcing approaches for maintaining comprehensive system state and history. In some implementations, asynchronous architectures might incorporate complex event processing capabilities, allowing for real-time analysis and reaction to patterns in the message or event stream. This could involve techniques like stream processing, complex event processing (CEP), or integration with machine learning models for predictive analytics. Alternative uses of asynchronous architectures include implementing long-running business processes or workflows, where different steps might be executed asynchronously over extended periods. Asynchronous architectures may also be used to build event-driven microservices architectures, enabling loose coupling and independent scalability of different system components.

The term “machine learning model” refers to one or more processes, algorithms, or other data entity that describes parameters, hyper-parameters, defined operations, or defined mappings of a model that is configured to process one or more inputs in accordance with one or more trained parameters of the machine learning models in order to generate a prediction. An example of a machine learning model is a mathematically derived algorithm (MDA). An MDA may comprise any algorithm trained using training data to predict one or more outcome variables. Without limitation, an MDA, as used herein, may comprise machine learning frameworks including neural networks, deep neural networks, generative adversarial networks, convolutional neural networks, recurrent neural networks, large language models, generative pre-trained transformers (GPT), support vector machines, gradient boosts, decision trees, random forests, Markov models, adaptive Bayesian techniques, and statistical models (e.g., timeseries-based forecast models such as autoregressive models, autoregressive moving average models, or an autoregressive integrating moving average models). Additionally, and without limitation, an MDA, as used in the singular, may include ensembles using multiple machine learning or statistical techniques.

### Example System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., user devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps.

Methods, apparatuses, and computer program products of the present disclosure may be embodied by any of a variety of devices. For example, the method, apparatus, and computer program product of an example embodiment may be embodied by a networked device (e.g., a federated software platform, or the like), such as a server or other network entity, configured to communicate with one or more devices, such as one or more query-initiating computing devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, the like or any combination of the aforementioned devices.

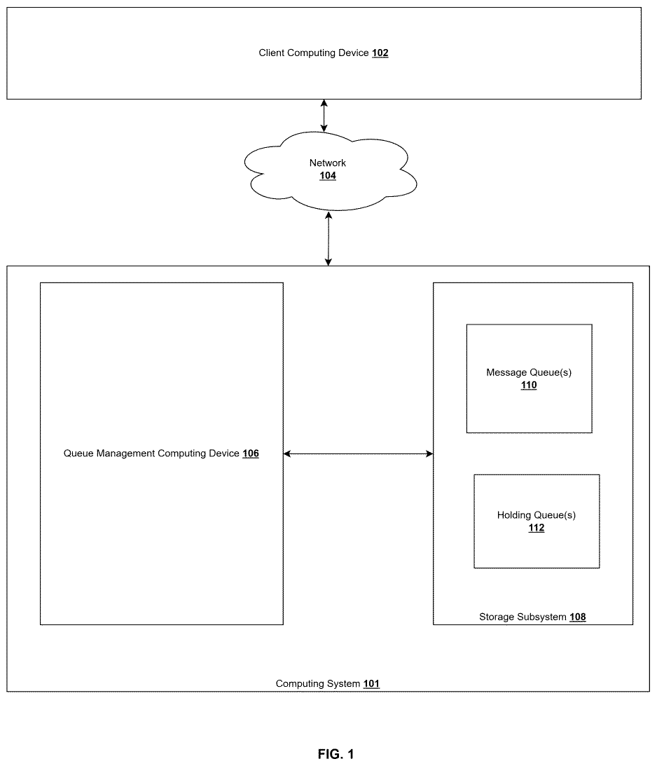

In this regard, FIG. 1 shows an example system architecture 100 within which embodiments of the present disclosure may operate. The depiction of the example system architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1 are shown as discrete, separate elements, other configurations may be used in connection with the methods, apparatuses, computer readable media, and computer programs described herein, including configurations that combine, omit, and/or add aspects and/or components.

As shown in FIG. 1 the system architecture 100 includes a computing system 101. The computing system 101 may communicate with one or more client computing devices 102 through a network 104. The computing system 101 may be or comprise services, microservices, a multi-layer service-oriented platform, and/or software application(s) that is configured for execution via one or more computing devices. The one or more computing devices and its associated components facilitate the configuring, execution, and management of various functionalities. Examples of a computing system 101 include Jira Service Management™, Opsgenie™ by Atlassian®, ITSM by Atlassian®, Jira service Desk by Atlassian®.

In some embodiments, the computing system 101 comprise an information technology service management system configured to support various information technology services including creating, planning, tracking, maintaining, and managing issues, tasks, alerts, requests, queues, incidents, problems, changes, reviews, and/or the like. Such system may include supporting application(s), service(s), server(s), repositor(ies), and/or client device(s) and may be configured to engage, or otherwise communicate, with external resources and/or external applications. In some embodiments, the computing system 101 comprise an incident management system or IT service management system configured to provide incident management functionalities for system users (e.g., organizations, members of organizations, customers of organizations, and/or the like) including streamlining alerts, sending instant notifications, and/or on-call scheduling. The computing system 101 may comprise, integrate, and/or leverage a message queue system to facilitate one or more functions of the computing system 101.

In some embodiments, the functions of one or more of the illustrated components in FIG. 1 may be performed by a single computing device or by multiple computing devices, which devices may be local or cloud based. It will be appreciated that the various functions performed by the computing system 101 (or portion thereof), the one or more client computing devices 102, and/or the various functions performed by the components of the computing system 101 may be embodied by a single apparatus, subsystem, or system comprising one or more sets of computing hardware (e.g., processor(s) and memory) configured to perform the various functions thereof. In some embodiments, one or more components of the computing system 101 may be embodied by a client computing device 102.

In various embodiments, the computing system 101 includes a queue management computing device 106 embodied in hardware, software, firmware, or a combination thereof configured to perform and/or support one or more functionalities including, handling of elevated queue message events associated with message queues, queue configuration update requests, and/or other queue reconfiguration triggers. The computing system 101 may be configured to provide, facilitate, and/or support message queuing functionality with respect to the computing system 101. Such message queuing functionality may include asynchronous communication between software components associated with and/or supported by one or more of components of the computing system 101.

As shown in FIG. 1, the computing system 101 includes or is associated with one or more message queues 110. Each message queue 110 may be associated with a queue identifier that uniquely identifies the respective message queue from other message queues. The one or more message queues 110 are configured to receive messages, directly or indirectly, from one or more client computing devices 102 and store the received messages until processed by a queue processor or otherwise removed from the message queue. A client computing device 102 may be associated with an entity such as an organization, enterprise, or other entities that utilize or otherwise is associated with one or more applications and/or platform associated with the computing system 101.

A message may comprise information/data such as request(s), error message(s), command(s), and/or the like originating form an entity via, for example, a client computing device 102 associated with the entity. A message may include a payload comprising the information/data being communicated and metadata such as headers, timestamps, and/or the like. A message stored via a message queue 110 may be read and processed by a queue processor associated with the computing system 101. For example, one or more of the components of the system architecture 100 may include one or more queue processors. In some embodiments, the computing system 101 may include one or more queue processors. In such some embodiments, at least a portion of the one or more queue processors may be embodied by the queue management computing device 106 as component(s) thereof or each of the one or more queue processors may be separate components within the computing system 101 relative to the queue management computing device 106.

The computing system 101 may include or is associated with one or more holding queues 112. In some embodiments, a holding queue 112 may comprise a dead-letter-queue. The one or more holding queues 112 may be configured for storing messages that the computing system 101 (e.g., queue processor(s) thereof) cannot process (e.g., due to errors) or otherwise routed to the one or more holding queues 112 according to a circuit-breakable queue processor framework described herein.

The queue management computing device 106 is configured via hardware, software, firmware, and/or a combination thereof to detect queue reconfiguration triggers including elevated queue message events associated with a message queue, queue configuration update requests, or the like. The queue management computing device 106 may leverage one or more techniques and/or models to detect queue reconfiguration triggers. In some embodiments, the queue management computing device 106 may be configured to detect an elevated queue message event by receiving an elevated queue message event indication (e.g., signal, data, computer readable instructions, messages, or the like indicative and/or representative of an elevated queue message event). In some embodiments, the queue management computing device 106 may be configured to receive elevated queue message event indication corresponding to an elevated queue message event from one or more other components within the computing system 101. Alternatively, or additionally, in some embodiments, the queue management computing device 106 may be configured to receive elevated queue message event indication corresponding to an elevated queue message event from the one or more client computing devices 102 or external system(s) (such as a third-party system). Such external system(s) may be communicatively coupled to the computing system 101 via one or more networks. In some embodiments, such one or more components withing the computing system 101, client computing device 102, or external system may include or is associated with a monitoring and alerting system that is leveraged to determine events such as elevated queue message events.

The queue management computing device 106 may be configured via hardware, software, firmware, and/or a combination thereof to dynamically filter incoming service messages that satisfy dynamic configuration criteria (e.g., configuration field subset) in response to an elevated queue message event.

The queue management computing device 106 may be configured via hardware, software, firmware, and/or a combination thereof to determine the dynamic configuration criteria for an elevated queue message event associated with a message queue based on a set of messages (e.g., service message set) within the message queue identified by the queue management computing device 106. In some embodiments, the identified set of messages may correspond to an entity identifier associated with the elevated queue message event. For example, in some scenarios, an elevated queue message event may be due to misconfiguration or other issues associated with the entity that caused the elevated queue message event. For example, the count/number of messages in the message queue may exceed a message count threshold due to sudden increased number of messages from the entity identifier.

The computing system 101 may include a storage subsystem 108. The storage subsystem 108 may be configured to store input data, configuration data, and/or the like that may be used by the computing system 101 and/or queue management computing device 106 to perform various functionalities associated therewith. In some embodiments, the storage subsystem 108 may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. Additionally, in some embodiments, the storage subsystem 108 may be configured to store one or more artificial intelligence/machine learning models.

In some embodiments, the storage subsystem 108 is configured to store one or more components of the computing system 101. For example, in the illustrated example computing system 101 depicted in FIG. 1, the storage subsystem 108 may store one or more message queues 110 and/or one or more holding queues 112. The components of the computing system 101 may be arranged in a distributed architecture. For example, the storage subsystem 108 may provide centralized data storage capabilities while various other components handle different aspects of circuit-breakable queue processor framework of the present disclosure and/or other functionalities associated with the computing system 101.

The various functions of the system architecture 100 may be performed by other arrangements of one or more computing devices or computing systems without departing from the scope of the present disclosure. For example, in an embodiment, one or more functions of the computing system 101 or queue management computing device 106 may be performed by a single computing device or computing system, or by multiple computing devices, which devices may be local or cloud based. In some embodiments, two or more of the depicted computing devices or computing systems may be part of a single system or device. For example, the one or more client computing devices 102 and the queue management computing device 106 may be part of the same local networked system or part of the same computing system (e.g., queue management computing device 106 may be a terminal or other front end portion associated with the computing system 101 or a larger system that includes both the queue management computing device 106 and the one or more client computing device 102). In some embodiments, two or more of the depicted devices or computing systems may be physically or electronically remote from each other (e.g., connected via the Internet). In some embodiments, the one or more message queues 110 and/or one or more holding queues 112 may be embodied by the client computing device 102 or part of the same computing system. It will be appreciated that the various functions performed by the queue management computing device 106 may be performed by a single apparatus, subsystem, or system. For example, queue management computing device 106 may include two or more components embodied by a single apparatus, subsystem, or system comprising one or more sets of computing hardware (e.g., processor(s) and memory) configured to perform various functions thereof.

Two or more of the components illustrated in the system architecture 100 illustrated in FIG. 1 may be configured to communicate via one or more communication mechanisms, including wired or wireless connections, such as over a network 104, bus, or similar connection. A network 104 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited, to TCP/IP based networking protocols. In some embodiments, the protocol is a custom protocol of JavaScript Object Notation (JSON) objects sent via a WebSocket channel. In some embodiments, the protocol is JSON over RPC, JSON over REST/HTTP, and/or the like.

In some embodiments, the components depicted in FIG. 1, although not required to be an integral system, may be connected via one or more networks. In some embodiments, one or more APIs may be leveraged to communicate with and/or facilitate communication between one or more of the components illustrated in the system architecture 100.

### Example Apparatuses

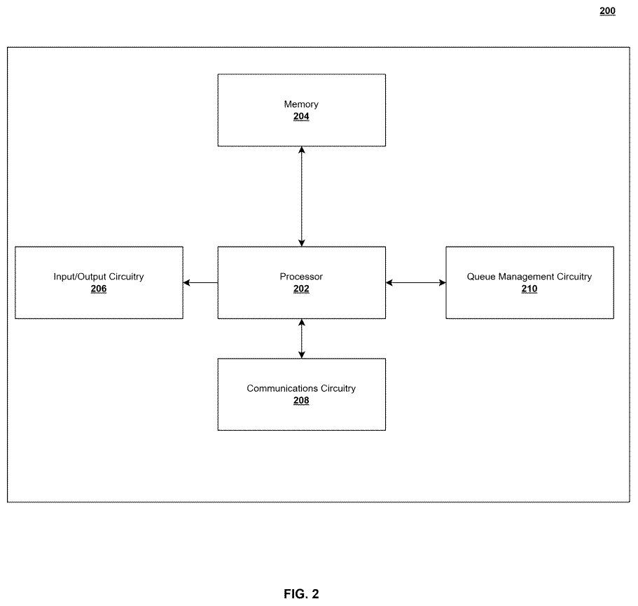

The example queue management computing device 106 may be embodied by one or more computing systems, such as apparatus 200 shown in FIG. 2. It should be noted, however, that the components, or elements illustrated in and described with respect to FIG. 2 may not be mandatory and thus one or more may be omitted in certain embodiments. Additionally, some embodiments, may include further or different components or elements beyond those illustrated in and described with respect to FIG. 2. In some embodiments, the apparatus 200 may comprise one or a plurality of physical devices.

The apparatus 200 may include processor 202, memory 204, input/output circuitry 206, communications circuitry 208, and queue management circuitry 210. The apparatus 200 may be configured to execute the operations described herein. Although these components 202-210 are described with respect to functional limitations, it should be understood that the particular implementations necessarily include the use of particular hardware. It should also be understood that certain of these components 202-210 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present invention.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

In some embodiments, the apparatus 200 may include a queue management circuitry 210 which may include hardware elements, with or without enabling software elements, firmware elements, or a combination thereof configured to, with the processor 202, input/output circuitry 206 or communications circuitry 208, perform one or more functions associated with the queue management computing device 106 (as described above with reference to FIG. 1). For example, the queue management circuitry 210 may access, facilitate access, receive, process, manipulate, provide, or otherwise use, or make available for use, certain data used by one or more other elements of the apparatus 200 through, for example, the use of hardware, software, applications, or APIs executed using a processor, such as the processor 202. In some embodiments, the queue management circuitry 210 may interact with the memory 204, which may store the aforementioned data. It should also be appreciated that, in some embodiments, the queue management circuitry 210 may include a separate processor, specially configured field programmable gate array (FPGA), or application specific interface circuit (ASIC) to receive such data utilized by the queue management circuitry 210. The queue management circuitry 210 may also provide for communication with other elements of the apparatus 200, system or external systems via a network interface provided by the communications circuitry 208. In some embodiments, one or more portions of the queue management circuitry 210 and processor 202 may be integrated into a single circuitry or group of circuitries, with or without various other circuitries discussed herein, configured to execute the respective functionalities thereof.

Additionally, or alternatively, in some embodiments, two or more of the sets of circuitries embodying processor 202, memory 204, input/output circuitry 206, communications circuitry 208, and/or queue management circuitry 210 are combinable. Alternatively, or additionally, in some embodiments, one or more of the sets of circuitry perform some or all of the functionality described associated with another component. For example, in some embodiments, two or more of the sets of circuitry embodied by processor 202, memory 204, input/output circuitry 206, communications circuitry 208, and queue management circuitry 210 are combined into a single module embodied in hardware, software, firmware, and/or a combination thereof. Similarly, in some embodiments, one or more of the sets of circuitry 202-210 is/are combined with the processor 202, such that the processor 202 performs one or more of the operations described above with respect to each of these sets of circuitry.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Example Data Flows, Operations, and Operational Examples

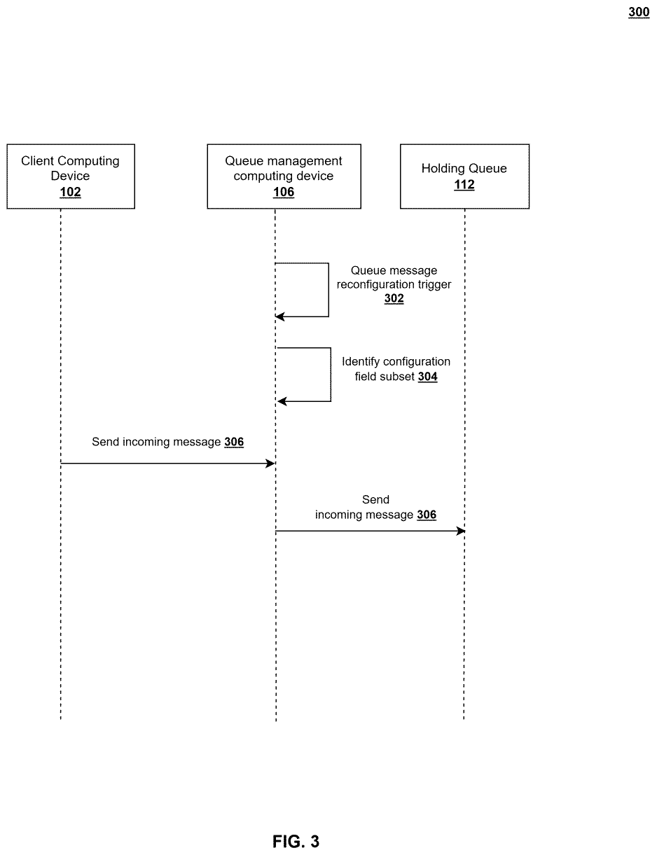

FIG. 3 illustrates a sequence diagram of example circuit-breakable queue processor framework for managing elevated queue message events, queue configuration update requests, or other events associated with message queues in accordance with at least some embodiments of the present disclosure. Using the various elements and techniques described herein, the computing system 101 (e.g., queue management computing device 106 thereof) may be configured to execute a circuit-breakable queue processor framework that includes identifying dynamic filtering criteria (e.g., configuration field subset) in response to detecting a queue reconfiguration trigger and filtering subsequent incoming service messages that satisfy the filtering criteria and/or performing other actions.

As shown in FIG. 3, the queue management computing device 106 detects a queue reconfiguration trigger 302. The queue reconfiguration trigger 302 may comprise or correspond to an elevated queue message event associated with a message queue, a queue configuration update request, or other queue events. In some embodiments, the queue reconfiguration trigger 302 may comprise a queue identifier and/or a queue identifier. In some embodiments, the message queue may be a selected message queue from a plurality of message queues. In some embodiments, a message queue may be designated as a selected message based on one or more criteria satisfied by the message queue. In some embodiments, the one or more criteria includes a priority level associated with the message queue, the elevated queue message event, the queue configuration update request, and/or other incident or event associated with the message queue.

An elevated queue message event may occur when a count of the messages (message count) in the message queue meets or exceeds a message count threshold. The queue management computing device 106 may employ on or more techniques to detect the elevated queue message event. In some examples, the queue management computing device 106 may comprise or leverage monitoring and alerting systems integrated with the message queue to detect the elevated queue message event. The monitoring and alerting systems may be configured continuously track queue metrics, such as message count, and generate elevated queue message events or alerts when a message count threshold for the message queue has been reached or exceeded. In some embodiments, the queue management computing device 106 may detect the elevated queue message event by receiving an elevated queue message event indication corresponding to the elevated queue message event, as described above with reference to FIG. 1.

In some embodiments, a queue configuration update request may comprise a request indicative and/or representative of a request to update (e.g., modify, change, or the like) the queue configuration for a message queue such as, but not limited to, routing rules associated with the message queue. In some embodiments, the computing system 101 may receive a queue configuration update request, directly or indirectly from a client computing device 102. In some embodiments, a queue configuration update request may be received via a user interface associated with and/or provided by the computing system 101 or the queue management computing device 106. In some embodiments, the queue configuration update request may be received via an API associated with the computing system 101 or queue management computing device 106.

As shown in FIG. 3, the queue management computing device 106 identifies a configuration field subset 304 based on the queue reconfiguration trigger 302 or otherwise in response to a queue reconfiguration trigger 302. The configuration field subset 304 may comprise one or more configuration fields leveraged by the computing system 101 (e.g., queue management computing device 106 thereof) to implement one or more actions with respect to a message queue or group of message queues. Such actions may include, but not limited to, dynamic filtering of incoming messages based on the configuration field subset 304. In some embodiments, the configuration field subset 304 comprises one or more configuration fields that are dynamically determined in response to the queue reconfiguration trigger 302.

In some embodiments, the configuration field subset 304 is determined based on the queue reconfiguration trigger 302. For example, the configuration field subset 304 may identify one or more features that may be leveraged to determine the configuration field subset 304. In some embodiments, the configuration field subset 304 is determined based on a service message set within the message queue. In some embodiments, the service message set may be identified based on the queue reconfiguration trigger 302. For example, the queue reconfiguration trigger 302 may comprise one or more features that identifies the service message set. Non-limiting examples of such one or more features includes an entity identifier associated with the service message set, a particular application or service associated with the service message set, or the like.

In some embodiments, where the queue reconfiguration trigger 302 comprises an elevated queue message event, the service message set may be indicative of the root cause of the elevated queue message event. For example, the count of messages in the message queue may exceed the message count threshold based on the service message set. For example, the service message set may be received within a particular length of time and the count of messages in the message queue may exceed the message count threshold based on the number of messages in the service message set. In some embodiments, the service message set may be associated with a particular entity or group of entities. In this regard, in some embodiments, in response to receiving a queue reconfiguration trigger 302 such as an elevated queue message event, the computing system 101 (e.g., queue management computing device 106 thereof) may be configured to identify a service message set within the message queue that is the root cause of the elevated queue message event, an entity that is the root cause of the elevated queue message event, or other features that is the root cause of the elevated queue message event.

In some embodiments, the computing system 101 (e.g., queue management computing device 106) may determine the service message set or root cause of an elevated queue message event based on data and/or metadata associated with the message queue such as count of messages associated with a particular entity over a particular length of time, timestamp associated with a message, and/or other data/metadata about or related to the message queue. For example, the computing system 101 (e.g., queue management computing device 106) may be configured to analyze data/metadata associated with the message queue to determine an entity associated with a sudden increase in the number of messages in the message queue.

The computing system 101 (e.g., queue management computing device 106) may leverage one or more analytical models to determine the particular entity. For example, the queue management computing device 106 may apply one or more analytical models to data/metadata associated with the message queue within a time window prior to the elevated queue message event. In some embodiments, the one or more analytical models may comprise one or more machine learning models. For example, in some embodiments, an analytical model may be type of machine learning model configured trained and/or the like to determine a root cause associated with an elevated queue message event based on data/metadata associated with the message queue. In some embodiments, identifying the configuration field subset 304 comprises receiving user input indicative of the configuration field subset 304 via a user interface associated with the queue management computing device 106.

In some embodiments, the configuration field subset 304 comprises an entity identifier field and/or other configuration fields. Such other configuration field may include message type, service identifier, incident identifier, and/or the like. It would be appreciated that the configuration field subset 304 may comprise one or more additional configuration fields and/or may omit the entity identifier field. In some embodiments, an entity identifier comprises one or more datum by which an entity may be identified. An entity identifier may be configured to uniquely identify an entity or group of entities from other entities.

As shown in FIG. 3, the computing system 101 (e.g., queue management computing device 106 thereof) dynamically filters subsequent incoming messages based on the configuration field subset 304 by determining the configuration data corresponding to the configuration field subset 304 defined by the service message set and evaluating the subsequent incoming service messages to determine if they match. In response to determining that a subsequent incoming service message 306 matches the configuration field subset 304, the computing system 101 (e.g., queue management computing device 106) filters out the subsequent incoming service message 306. For example, the computing system 101 (e.g., queue management computing device 106 thereof) may transmit computer-executable instructions configured to cause the subsequent incoming service message 306 to be filtered (e.g., removed) from the message queue. In some examples, the computing system 101 (e.g., queue management computing device 106 thereof) may transmit computer-executable instructions configured to cause the subsequent incoming service message 306 to be filtered (e.g., removed) before receiving by the message queue, such that the subsequent incoming service message is routed away from the message queue. In some embodiments, the computing system 101 (e.g., queue management computing device 106) moves (e.g., routes, redirects, or similar terms) the subsequent incoming service message 306 to a holding queue 112. For example, the computing system 101 (e.g., queue management computing device 106 thereof) may transmit computer-executable instructions configured to cause routing of the subsequent incoming service message 306 to a holding queue 112. In some embodiments, the queue management computing device 106 deletes the subsequent incoming service message 306. For example, the computing system 101 (e.g., queue management computing device 106 thereof) may transmit computer-executable instructions configured to cause deletion of the subsequent incoming service message 306.

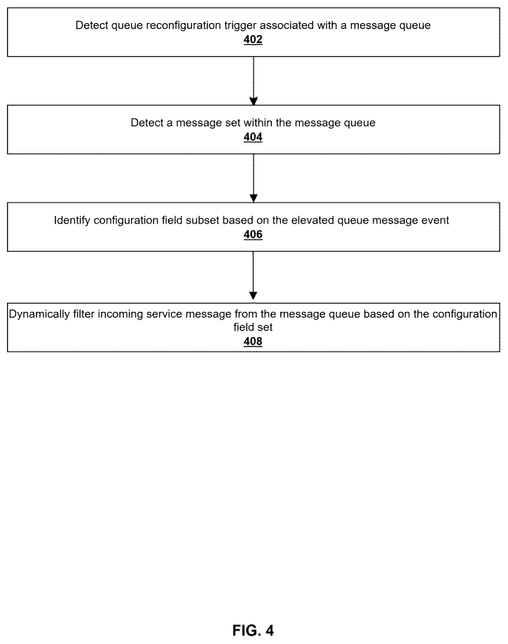

FIG. 4 illustrates a flowchart of an example process 400 for circuit-breakable queue processor in accordance with at least some embodiments of the present disclosure. The process 400 may be implemented by one or more computing devices, apparatuses, entities, and/or systems described herein. For example, the process 400 may be a computer-implemented method. FIG. 4 illustrates an example process 400 for explanatory purposes. Although the example process 400 depicts a particular sequence of steps/operations, the sequence may be altered without departing from the scope of the present disclosure. For example, some of the steps/operations depicted may be performed in parallel or in a different sequence that does not materially impact the function of the process 400. In other examples, different components of an example device or system that implements the process 400 may perform functions at substantially the same time or in a specific sequence.

In some embodiments, the process 400 includes at step/operation 402, detecting a queue reconfiguration trigger such as, for example, an elevated queue message event associated with a message queue (e.g., a selected message queue), a queue configuration update request, or the like. In some embodiments, the message queue is associated with a selected service (e.g., a particular service from a plurality of services associated with an application, system, or platform such as a multi-layer service-oriented platform) In some embodiments, detecting an elevated queue message event comprises determining a message count associated with the message queue exceeds a message count threshold.

In some embodiments, the process 400 includes at step/operation 404, detecting a service message set within the message queue. For example, the service message set may be the root cause of an elevated queue message event or may be associated with a particular entity that is the root cause of the elevated queue message event (e.g., that at least partially caused the count of messages in the message queue to exceed the message count threshold based on messages received from the entity). In some embodiments, each service message of the service message set defines a service message configuration field set.

In some embodiments, the process 400 includes at step/operation 406 identifying configuration field subset of the service message configuration field set based on the service message set. In some embodiments, the configuration field subset comprises an entity identifier field and/or other configuration fields associated with the service message configured field set.

In some embodiments, the process 400 includes at step/operation 408, dynamically filtering at least one subsequent incoming service message from the message queue based on the configuration field subset. In some embodiments, dynamically filtering the at least on subsequent incoming service based on the configuration field subset comprises detecting the at least one subsequent incoming service message, determining configuration field data corresponding to the configuration field subset for the at least one subsequent incoming service message, comparing the configuration field data to a target configuration field data, and dynamically filtering the configuration field subset in response to determining that the configuration field data matches the target configuration field data. In some embodiments, the target configuration field data comprises at least an entity identifier associated with the service message set.

In some embodiments, dynamically filtering the subsequent incoming service message comprises deleting the subsequent incoming service message in response to receiving the subsequent incoming service message. In some embodiments, dynamically filtering the subsequent incoming service message comprises routing the subsequent incoming service message to a holding queue.

In some embodiments, the service message set or a portion of the service message set is moved/routed to a holding queue. In some embodiments, the service message set or portion of the service message set is deleted from the message queue.

A number of implementations have been described. Nevertheless, it will be understood that various modifications may be made without departing from the spirit and scope of the disclosure. Accordingly, other implementations are within the scope of the following claims.

### Additional Implementation Details

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates a limited interaction mode and/or a non-limited interaction mode for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language page), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random-access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending pages to and receiving pages from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

### CONCLUSION

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A computer-implemented method for circuit-breakable queue processor framework, the computer-implemented method comprising:
detecting a queue reconfiguration trigger associated with a selected message queue of a plurality of message queues for a selected service;
detecting a service message set within the selected message queue based on the queue reconfiguration trigger, wherein each service message of the service message set defines a service message configuration field set;
identifying a configuration field subset of the service message configuration field set based on the queue reconfiguration trigger; and
dynamically filtering at least one subsequent incoming service message from the selected message queue based on the configuration field subset.

2. The computer-implemented method of claim 1, wherein the configuration field subset comprises an entity identifier field.

3. The computer-implemented method of claim 1, wherein dynamically filtering the at least one subsequent incoming service message based on the configuration field subset comprises:
detecting the at least one subsequent incoming service message;
determining configuration field data corresponding to the configuration field subset for the at least one subsequent incoming service message;
comparing the configuration field data to a target configuration field data; and
dynamically filtering the configuration field subset in response to determining that the configuration field data matches the target configuration field data.

4. The computer-implemented method of claim 3, wherein the target configuration field data comprises an entity identifier associated with the service message set.

5. The computer-implemented method of claim 1, wherein dynamically filtering the at least one subsequent incoming service message comprises deleting the at least one subsequent incoming service message in response to receiving the at least one subsequent incoming service message.

6. The computer-implemented method of claim 1, wherein dynamically filtering the at least one subsequent incoming service message comprises moving the at least one subsequent incoming service message to a holding queue.

7. The computer-implemented method of claim 1, further comprising moving the service message set from the selected message queue to a holding queue.

8. The computer-implemented method of claim 1, further comprising deleting the service message set from the selected message queue.

9. The computer-implemented method of claim 1, wherein the queue reconfiguration trigger comprises an elevated queue message event, wherein detecting the queue reconfiguration trigger comprises determining a message count associated with the selected message queue exceeds a message count threshold.

10. An apparatus for circuit-breakable queue processor framework, the apparatus comprising at least one processor and at least one memory including program code, the at least one memory and the program code configured to, with the at least one processor, cause the apparatus to at least:
detect an elevated queue message event associated with a selected message queue of a plurality of message queues for a selected service;
detect a service message set within the selected message queue based on the elevated queue message event, wherein each service message of the service message set defines a service message configuration field set;
identify a configuration field subset of the service message configuration field set based on the elevated queue message event; and
dynamically filter at least one subsequent incoming service message from the selected message queue based on the configuration field subset.

11. The apparatus of claim 10, wherein dynamically filtering the at least one subsequent incoming service message based on the configuration field subset comprises:
detecting the at least one subsequent incoming service message;
determining configuration field data corresponding to the configuration field subset for the at least one subsequent incoming service message;
comparing the configuration field data to a target configuration field data; and
dynamically filtering the configuration field subset in response to determining that the configuration field data matches the target configuration field data.

12. The apparatus of claim 11, wherein dynamically filtering the at least one subsequent incoming service message comprises deleting the at least one subsequent incoming service message in response to receiving the at least one subsequent incoming service message.

13. The apparatus of claim 10, wherein dynamically filtering the at least one subsequent incoming service message comprises moving the at least one subsequent incoming service message to a holding queue.

14. The apparatus of claim 10, wherein the apparatus is further causes to move the service message set from the selected message queue to a holding queue.

15. The apparatus of claim 10, wherein the apparatus is further caused to delete the service message set from the selected message queue.

16. The apparatus of claim 10, wherein detecting the elevated queue message event comprises determining a message count associated with the selected message queue exceeds a message count threshold.

17. The apparatus of claim 10, wherein the configuration field subset comprises at least an entity identifier field.

18. At least one non-transitory computer-readable storage medium for circuit-breakable queue processor framework, the at least one non-transitory computer-readable storage medium having computer coded instructions configured to, when executed by at least one processor:
detect a queue reconfiguration trigger associated with a selected message queue of a plurality of message queues for a selected service;
detect a service message set within the selected message queue based on the queue reconfiguration trigger, wherein each service message of the service message set defines a service message configuration field set comprising at least an entity identifier field;
identify a configuration field subset of the service message configuration field set based on the queue reconfiguration trigger; and
dynamically filter at least one subsequent incoming service message from the selected message queue based on the configuration field subset.

19. The at least one non-transitory computer-readable storage medium of claim 18, wherein the queue reconfiguration trigger comprises an elevated queue message event, wherein detecting the queue reconfiguration trigger comprises determining a message count associated with the selected message queue exceeds a message count threshold.

20. The at least one non-transitory computer-readable storage medium of claim 18, wherein dynamically filtering the at least one subsequent incoming service message based on the configuration field subset comprises:
detecting the at least one subsequent incoming service message;
determining configuration field data corresponding to the configuration field subset for the at least one subsequent incoming service message;
comparing the configuration field data to a target configuration field data; and
dynamically filtering the configuration field subset in response to determining that the configuration field data matches the target configuration field data, wherein dynamically filtering the at least one subsequent incoming service message comprises moving the at least one subsequent incoming service message to a holding queue.
